(19) United States
(12) Patent Application Publication
(10) Pub. No.: US 2006/0212742 A1
(43) Pub. Date: Sep. 21, 2006

(54) Prompt backup/recovery system and methods regarding the same

(75) Inventors: Rick Sun, Chongqing (CN); Makson Zhao, Chongqing (CN)

Correspondence Address: ARENT FOX PLLC, 1050 CONNECTICUT AVENUE, N.W., SUITE 400, WASHINGTON, DC, 20036, US

(73) Assignee: FARSTONE TECH INC

(21) Appl. No.: 11/375,574

(22) Filed: Mar. 15, 2006

(30) Foreign Application Priority Data
Mar. 15, 2005 (TW) 94107767

(51) Int. Cl. G06F 11/00

(52) U.S. Cl. 714/4

(57) ABSTRACT

A backup/recovery system and methodology that provides seamless networking. According to the invention, backup/recovery system is suitable for a network. The backup/recovery system includes a server part and at least one client part for storing at least one incremental recovery point. The at least one client part sends at least one incremental recovery point to the server part. The at least one incremental recovery point instantaneously stores data that has been changed, so as to economize the use of storage space occupied by the backup data, and enhance the efficiency of recovery operation.

### BACKGROUND OF THE INVENTION

1. Field of the Invention

The present invention relates generally to a backup/recovery technique for a computer system, and more particularly to a backup/recovery system and method that efficiently backs up data of a client computer system to a server.

2. Description of Prior Art

Conventional backup/recovery software creates recovery points to backup data. The valid data of the hard disk is backed up prior to making changes to the data. Such backup/recovery software restores the computer system to a previous state, in accordance with the previous backup data, from a current state. The restoration process of the backup/recovery software depends on the current state of the data in the hard disk.

If there is not much change of the data, the data amount to be backed up will be relatively small. But changes to the data in the hard disk usually grow in quantity as the time goes by. As such, the incremental recovery points and the valid data to be backed up will also increase. The increment of the size of the backup data gradually brings about a shortage of the storage space for storing data in the hard disk. User need to delete outdated recovery points and consolidate the incremental recovery points as a method for freeing up hard disk space for more current recovery point.

To save the storage space in the hard disk of user, some presently available backup/recovery software keeps all previously created recovery points to a server. However, the server may accommodate lots of users with a backup storage. This, however, makes load of the server extremely high.

### SUMMARY OF THE INVENTION

The present invention provides a backup/recovery system and method to resolve the foregoing problems faced by the conventional backup/recovery software. The present invention also has the advantage of solving the problem of the storage shortage.

An object of the present invention is to provide a backup/recovery system and method, wherein recovery points can be kept either in a server or in a computer system of the user.

Another object of the present invention is to provide a backup/recovery system and method, which can keep incremental recovery points in a server, in order to reduce the amount of backed up data. Moreover, the recovery operation can be completed instantaneously

A further object of the present invention is to provide a backup/recovery system and method, which can implement the recovery operation without user's consciousness of locations of the recovery points.

In accordance with an aspect of the present invention, a backup system is suitable for a network. The backup/recovery system includes a server part and at least one client part for storing at least one incremental recovery point. The at least one client part sends at least one incremental recovery point to the server part. The at least one incremental recovery point instantaneously stores data that has been changed.

In the preferred embodiment of the invention, the at least one client part generates a storing tag for tagging whether the server part stores backed up data of the at least one client part. The server part sends the at least one client part permission to transmit the backed up data. The at least one client part sends request of terminating the transmission, to the server part. The server part verifies the backed up data from the at least one client part. The at least one client part deletes the backed up data stored therein. The at least one client part computes the backed up data stored in the server part and the own at least one incremental recovery point. The server part deletes the backed up data that has been transmitted back to the at least one client part.

The present invention may best be understood through the following description with reference to the accompanying drawings, in which:

### BRIEF DESCRIPTION OF THE DRAWINGS

FIG. 1 shows a schematic block diagram of a backup/recovery system of a preferred embodiment according to the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for the purpose of illustration and description only. It is not intended to be exhaustive or to be limited to the precise form disclosed.

The present invention describes a new backup technique for a backup/recovery system to keep at least one incremental recovery point in a server, which can enhance backup space. Moreover, the users will have no difficulty in aware of locations of the recovery points.

With the backup technique of the present invention, the users can securely back up every data and keep the states of previously stored backup data efficiently. The storage space in the computer system of the user can be economized. Therefore, the drawbacks faced by the prior arts can be solved completely.

According to the preferred embodiment of the present invention, a backup/recovery system is suitable for a network. The backup/recovery system includes a server part and at least one client part for storing at least one incremental recovery point. The at least one client part sends at least one incremental recovery point to the server part. The at least one incremental recovery point instantaneously stores data that has been changed.

The at least one client part generates a storing tag for tagging whether the server part stores backed up data of the at least one client part. The server part sends the at least one client part permission to transmit the backed up data. The at least one client part sends request of terminating the transmission, to the server part. The server part verifies the backed up data from the at least one client part. The at least one client part deletes the backed up data stored therein. The at least one client part computes the backed up data stored in the server part and the own at least one incremental recovery point. The server part deletes the backed up data that has been transmitted back to the at least one client part.

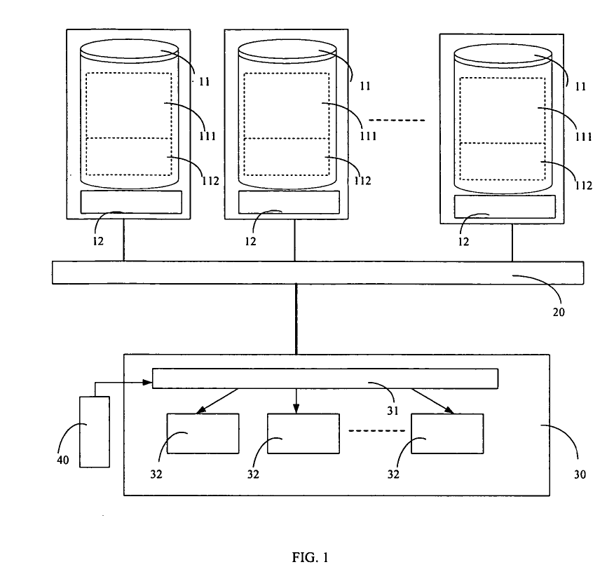

Referring to FIG. 1, a schematic block diagram of a backup/recovery system of a preferred embodiment according to the present invention is shown. The backup/recovery system of the present invention is suitable for a network 20. The backup/recovery system includes a server part 30 and at least one client part 10.

The network 20 maintains communication between a server management part 31 and a client management part 12. The client management part 12 executes a client management program at the client parts 10. The server management part 31 executes a server management program at the server part 30. The server part 30 may remotely control backup/recovery operation of the client parts 10.

The at least one client part 10 stores at least one incremental recovery point 112. The at least one incremental recovery point 112 may contain only incremental changes made to valid data 111 of a hard disk 11. The at least one incremental recovery point 112 instantaneously stores data that has been changed. Incremental recovery points 112 are created faster and use less storage space than a complete copy of the hard disk 11.

Over time, the recovery point storage can be used up. If there is a shortage of the storage space for keeping the at least one incremental recovery point 112 in the hard disk 11, the at least one client part 10 could send at least one incremental recovery point 112 to the server part 30. The at least one incremental recovery point 112 sent to the server part 30 is created at an earlier time.

Upon receiving a request for sending incremental recovery point 112, the server management part 31 of the server part 30 executes an initiate procedure. A private space 32 is partitioned and allocated to such client part 10. The server part 30 sends the client part 10 permission to transmit the backed up data contained in the at least one incremental recovery point 112.

After transmission of the backed up data is completed, the at least one client part 10 sends request of terminating the transmission, to the server part 30. The server management part 31 of the server part 30 verifies the backed up data from the client part 10. The backup/recovery method of the present invention includes a manager 40 to manage and optimize the recovery points.

The client part 10 deletes the backed up data previously stored therein. By changing the location of where the recovery points are stored, such recovery points can be cleaned up that are taking up valuable hard disk space of the client part 10. The client management part 12 of the client part 10 generates a storing tag for tagging backed up data of the client part 10 has been stored into the server part 30.

When the computer of the client part 10 is working normally, user restores it back to a date and time when it was working correctly. When it starts the recovery process, the computer of the client part 10 obtains messages regarding the recovery point storage of the client part 10.

If there is a storing tag in the client part 10, the client part 10 computes the backed up data received from the server part 30 and the own at least one incremental recovery point 112, if any. The computer of the client part 10 can then be recovered and restored in seconds. The server part can then delete the backed up data that has been transmitted back to the client part 10, to economize the use of storage space occupied.

The present invention puts backup data in backup space of the server part 30 so that the computer of the client part 10 can effectively solved the storage shortage problem of the recovery points faced by the conventional backup/recovery software. The present invention also ensures the backup data won't be accessed by other clients. Hence, the shortcoming that the computer system cannot be restored to a normal state can be entirely avoided.

While the invention has been described in terms of what are presently considered to be the most practical and preferred embodiments, it is to be understood that the invention need not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A backup system, suitable for a network, said backup system comprising:
at least one client part for storing at least one incremental recovery point; and
a server part,
wherein said at least one client part sends at least one incremental recovery point to said server part, said at least one incremental recovery point instantaneously storing data that has been changed.

2. The backup system according to claim 1, wherein said at least one client part generates a storing tag for tagging whether said server part stores backed up data of said at least one client part.

3. The backup system according to claim 2, wherein said server part sends said at least one client part permission to transmit said backed up data.

4. The backup system according to claim 3, wherein said at least one client part sends request of terminating said transmission, to said server part.

5. The backup system according to claim 4, wherein said server part verifies said backed up data from said at least one client part.

6. The backup system according to claim 5, wherein said at least one client part deletes said backed up data stored therein.

7. The backup system according to claim 2, wherein said at least one client part computes said backed up data stored in said server part and said own at least one incremental recovery point.

8. The backup system according to claim 7, wherein said server part deletes said backed up data that has been transmitted back to said at least one client part.
